(19) United States
(12) Patent Application Publication
(10) Pub. No.: US 2026/0060779 A1
(43) Pub. Date: Mar. 5, 2026

(54) LASER APPARATUS FOR MACHINING DENTAL HARD TISSUE

(71) Applicant: JenLab GmbH, Berlin (DE)

(72) Inventor: Karsten Koenig, Berlin (DE)

(21) Appl. No.: 19/317,682

(22) Filed: Sep. 3, 2025

(30) Foreign Application Priority Data
Sep. 5, 2024 (DE) 102024125401.7

(51) Int. Cl. A61C 1/00; B23K 26/40

(52) U.S. Cl. CPC A61C 1/0046; B23K 26/40

(57) ABSTRACT

A laser apparatus for machining dental hard tissue including a first ultrashort pulse laser beam source for providing a machining laser beam which is adapted to apply the machining laser beam to a predetermined treatment area of dental hard tissue, a second laser beam source for providing a pilot laser beam which is adapted to induce a fluorescence of pathogenic bacteria which marks the treatment area, and an application device for applying an absorber material to an area of dental hard tissue to be machined. The first laser beam source is formed in such a way that the absorber material is transitioned to a higher energy state by the absorption of the machining laser beam.

### PRIORITY CLAIM

The present application claims priority to German Patent Application No. 10 2024 125 401.7, filed on Sep. 5, 2024, which said application is incorporated by reference in its entirety herein.

### FIELD OF THE INVENTION

The invention is directed to a laser apparatus for machining dental hard tissue. The invention relates to the technical field of dental lasers.

### BACKGROUND OF THE INVENTION

In dentistry, particularly in caries therapy, an important goal consists in replacing conventional mechanical drilling apparatus entirely or at least partially by laser machining devices.

Pulsed Er:YAG laser systems have been used heretofore for this purpose to enable high-quality tooth ablation.

EP 2389271 B1 discloses a laser machining apparatus for ablating material in which a photosensitizer is excited with a pulsed machining laser beam and the excited photosensitizer releases oxygen radicals which are conducive to the laser ablation process.

In heretofore commercially available laser machining apparatus based on pulsed Er:YAG lasers for ablating tooth material, water is used to promote the process of ablating dental hard tissue through the absorption of the laser beam by the water film. In particular, the threshold for the ablation process can be lowered by the initial absorption through water.

Conventional dental treatment lasers such as the Er:YAG laser do not have a module for online monitoring and analysis. Further, they are inferior to ultrashort pulse lasers in terms of precision.

The commercially available devices have the drawback that a water film must be used which leads to the formation of aerosols. Aerosols promote the spread of viruses and bacteria. The disadvantage in using a photosensitizer is that, up to the present, only a few photosensitizers have been clinically usable and they are required to generate oxygen radicals. However, oxygen radicals are harmful to soft dental tissue.

### SUMMARY OF THE INVENTION

Therefore, it is an object of the invention to provide a laser apparatus which overcomes the disadvantages of the prior art and which allows precise ablation of material without damaging surrounding dental soft tissue.

This object is met by a laser apparatus for machining dental hard tissue having the features of independent claim 1. Advantageous embodiment forms are the subject matter of the associated subclaims.

In an embodiment, the invention comprises a laser apparatus for machining dental hard tissue which comprises: (i) a first ultrashort pulse laser beam source for providing a machining laser beam, this first ultrashort pulse laser beam source being adapted to apply the machining laser beam to a predetermined treatment area of dental hard tissue; (ii) a second laser beam source for providing a pilot laser beam which is adapted to induce a fluorescence of pathogenic bacteria which marks the treatment area; and (iii) an application device for applying an absorber material to an area of dental hard tissue to be machined, the first laser beam source being formed in such a way that the absorber material is transitioned to a higher energy state by the absorption of the machining laser beam. In this way, a more precise ablation of the material to be machined can be carried out by multiphoton absorption with an appreciably lower ablation threshold than in the absence of absorber material without damaging dental soft tissue.

In a particularly advantageous manner, the pulse duration of the machining laser beam lies within a range of from 15 fs to 20 ps, preferably within a range of from 20 fs to 1 ps, particularly preferably within a range of from 200 fs to 1 ps. This leads to a precise ablation through multiphoton ablation without destructive side effects due, for example, to the destructive effect of shock waves.

In an advantageous aspect, it is provided that the wavelength of the pilot laser beam lies within a range of from 400 to 630 nm, preferably within a range of from 400 to 540 nm, particularly preferably within a range of from 400 to 410 nm. In this way, it is possible to efficiently excite porphyrin-producing pathogenic bacteria to fluoresce in the red spectral range.

According to a preferred aspect, the laser apparatus further comprises at least one photon detector for detecting a fluorescence in the red spectral range and/or a frequency doubling and/or a frequency tripling and/or for detecting the plasma occurring during the machining of dental hard tissue. This makes it possible to monitor the ablation of material while the dental hard tissue is being machined.

According to a preferred aspect, the absorber material comprises pigments of a black marker and/or black ink and/or blue ink. Accordingly, conventional markers and/or inks may be used as inexpensive absorber material.

The absorber material is advantageously sprayed on and/or brushed on and/or painted on. This makes it possible to reliably and quickly apply the absorber material to the dental hard tissue.

The application device is advantageously a spray device and/or a brush and/or a pen. This makes it possible to uniformly and quickly apply the absorber material to the dental hard tissue.

It has turned out to be advantageous when a method for machining dental hard tissue by means of a laser apparatus comprises the following steps:
b) providing a pulsed machining laser beam by means of a first ultrashort pulse laser beam source;
c) applying an absorber material to a predetermined area of dental hard tissue by means of an application device;
d) irradiating the absorber material with the machining laser beam and selecting the intensity and wavelength of the machining laser beam such that the absorber material is transitioned to a higher energy state through the absorption of the machining laser beam.

This makes it possible to use more cost-effective laser systems with lower energy requirements because the ablation of the dental hard tissue to be machined can be carried out by means of multiphoton absorption with an appreciably lower ablation threshold than without absorber material.

In an advantageous aspect, it is provided that the predetermined area of dental hard tissue is irradiated in a step a) with a pilot laser beam, and the wavelength of the pilot laser beam is selected in such a way that pathogenic bacteria emit fluorescence, as a result of which the predetermined area of dental hard tissue is limited to a treatment area damaged by pathogenic bacteria. This makes it possible to identify the position at which the treatment laser beam must be aimed.

It is particularly advantageous when the application of the absorber material in step c) is carried out exclusively in the treatment area damaged by pathogenic bacteria. This allows for a substantially gentler treatment without healthy dental hard tissue being affected detrimentally by laser radiation.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

The invention will be described more fully in the following based on exemplary embodiments with reference to the accompanying drawings, which also disclose features essential to the invention. These exemplary embodiments are merely illustrative and are not to be construed as limiting. For example, a description of an exemplary embodiment having a plurality of elements or components is not to be interpreted as meaning that all of these elements or components are necessary for implementation. Rather, other exemplary embodiments may also include alternative elements and components, fewer elements or components, or additional elements or components. Elements or components of different embodiment examples may be combined with each other unless otherwise indicated. Modifications and variations described for one of the embodiment examples may also be applicable to other embodiment examples. To avoid repetition, identical or corresponding elements in different figures are designated by the same reference characters and are not explained more than once. The drawings show:

FIG. 1 a schematic representation of a laser apparatus according to the invention; and

FIG. 2 a schematic representation of a flow of a method according to the invention for machining dental hard tissue by means of a laser apparatus according to the invention.

### DETAILED DESCRIPTION

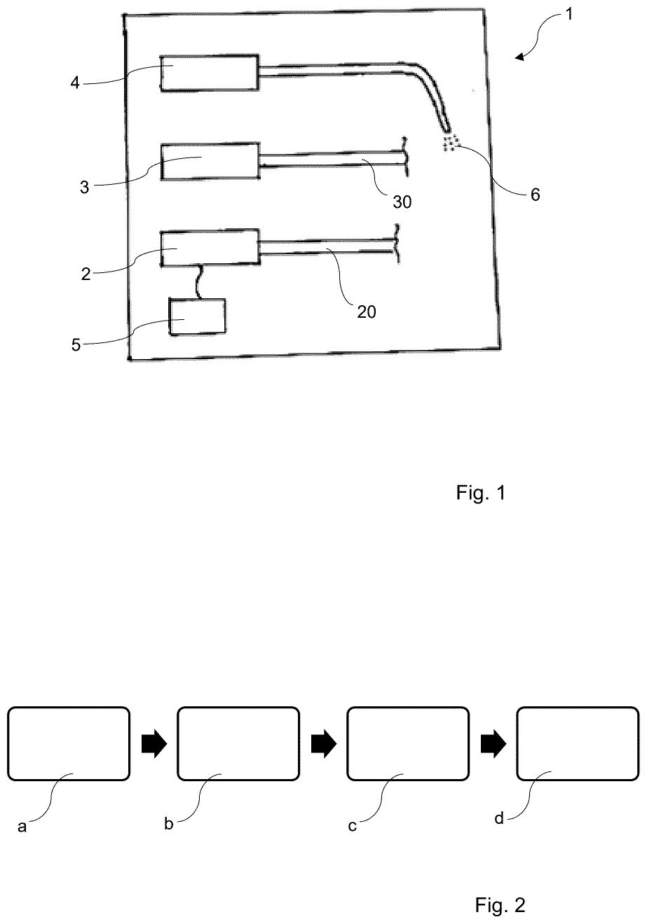

FIG. 1 shows a laser apparatus 1 according to the invention for machining dental hard tissue, comprising a first ultrashort pulse laser beam source 2 for providing a machining laser beam 20 which is adapted to apply the machining laser beam 20 to a predetermined treatment area of dental hard tissue. A second laser beam source 3, for example, a continuously emitting beam source for providing a pilot laser beam 30, is adapted to induce a fluorescence of pathogenic bacteria marking the treatment area. This relies on the pathogenic, e.g., porphyrin-producing, bacteria absorbing portions of the pilot laser beam 30 and inducing a fluorescence. The fluorescence lies, for example, in the red spectral range and in the near infrared spectral range with maxima at approximately 635 - 710 nm. The laser apparatus further comprises an application device 4 for applying an absorber material 6 to an area of dental hard tissue to be machined. The absorber material 6 can absorb portions of the machining laser beam 20 by means of single-photon absorption. The first laser beam source 2 is formed in such a way that the absorber material 6 is transitioned to a higher energy state by the absorption of the machining laser beam 20. Accordingly, an interaction of the machining laser beam 20 with the absorber material 6 is brought about such that a higher energy state can be obtained by means of single-photon absorption.

The application device 4 is a spray device and/or a brush and/or a pen.

The wavelength of the pilot laser beam 30 lies within a range of from 400 to 630 nm, preferably within a range of from 400 to 540 nm, particularly preferably within a range of from 400 to 410 nm.

The pulse duration of the machining laser beam 20 lies within a range of from 15 fs to 20 ps, preferably within a range of from 20 fs to 1 ps, particularly preferably within a range of from 200 fs to 1 ps.

The laser apparatus 1 further comprises at least one photon detector 5 for detecting a fluorescence in the red spectral range and/or a frequency doubling and/or a frequency tripling and/or for detecting the plasma occurring during the machining of the dental hard tissue. The fluorescence is, for example, a two-photon-excited and/or three-photon-excited fluorescence.

FIG. 2 shows a schematic diagram of a flow of a method according to the invention for machining dental hard tissue by means of a laser apparatus 1 according to the invention. The method comprises the following steps:
b) providing a pulsed machining laser beam 20 by means of a first ultrashort pulse laser beam source 2;
c) applying an absorber material 6 to a predetermined area of dental hard tissue by means of an application device 4;
d) irradiating the absorber material 6 with the machining laser beam 20 and selecting the intensity and wavelength of the machining laser beam 20 such that the absorber material 6 is transitioned to a higher energy state through the absorption of the machining laser beam 20.

The absorption of the machining laser beam 20 is, for example, a single-photon absorption.

In a step a), the predetermined area of dental hard tissue is irradiated with a pilot laser beam 30. The wavelength of the pilot laser beam 30 is selected in such a way that pathogenic bacteria emit fluorescence, as a result of which the predetermined area of dental hard tissue is limited to a treatment area damaged by pathogenic bacteria.

The application of absorber material 6 in step c) is carried out exclusively in the treatment area damaged by pathogenic bacteria.

The absorber material 6 comprises pigments of a black marker and/or black ink and/or blue ink and is sprayed on and/or brushed on and/or painted on.

### REFERENCE NUMERALS

1 laser device
2 first laser beam source
3 second laser beam source
4 application device
5 photon detector
6 absorber material
20 machining laser beam
30 pilot laser beam

1. A laser apparatus for machining dental hard tissue, comprising:
a first ultrashort pulse laser beam source for providing a machining laser beam which is adapted to apply the machining laser beam to a predetermined treatment area of dental hard tissue,
a second laser beam source for providing a pilot laser beam which is adapted to induce a fluorescence of pathogenic bacteria marking the treatment area, and
an application device for applying an absorber material to an area of dental hard tissue to be machined,
wherein the first laser beam source is formed in such a way that the absorber material is transitioned to a higher energy state by the absorption of the machining laser beam.

2. The laser apparatus according to claim 1, wherein the wavelength of the pilot laser beam lies within a range of 400 to 630 nm.

3. The laser apparatus according to claim 1, wherein the wavelength of the pilot laser beam lies within a range of 400 to 540 nm.

4. The laser apparatus according to claim 1, wherein the wavelength of the pilot laser beam lies within a range of 400 to 410 nm.

5. The laser apparatus according to claim 1, wherein the pulse duration of the machining laser beam lies within a range of 15 fs to 20 ps.

6. The laser apparatus according to claim 1, wherein the pulse duration of the machining laser beam lies within a range of 20 fs to 1 ps.

7. The laser apparatus according to claim 1, wherein the pulse duration of the machining laser beam lies within a range of 200 fs to 1 ps.

8. The laser apparatus according to claim 1, further comprising at least one photon detector for detecting a fluorescence in the red spectral range and/or a frequency doubling and/or a frequency tripling and/or for detecting the plasma occurring during the machining of the dental hard tissue.

9. The laser apparatus according to claim 1, wherein the application device is a spray device and/or a brush and/or a pen.

10. A method for machining dental hard tissue using the laser apparatus according to claim 1, comprising the following steps:
b) providing a pulsed machining laser beam via a first ultrashort pulse laser beam source;
c) applying an absorber material to a predetermined area of dental hard tissue via an application device;
d) irradiating the absorber material with the machining laser beam and selecting the intensity and wavelength of the machining laser beam such that the absorber material is transitioned to a higher energy state through the absorption of the machining laser beam.

11. The method according to claim 10, wherein the predetermined area of dental hard tissue is irradiated in a step a) with a pilot laser beam, wherein the wavelength of the pilot laser beam is selected in such a way that pathogenic bacteria emit fluorescence, as a result of which the predetermined area of dental hard tissue is limited to a treatment area damaged by pathogenic bacteria.

12. The method according to claim 10, wherein the application of absorber material in step c) is carried out exclusively in a treatment area damaged by pathogenic bacteria.

13. The method according to claim 10, wherein the absorber material comprises pigments of a black marker and/or black ink and/or blue ink.

14. The method according to claim 10, wherein the absorber material is sprayed on and/or brushed on and/or painted on.
